(19) United States
(12) Patent Application Publication
(10) Pub. No.: US 2013/0024431 A1
(43) Pub. Date: Jan. 24, 2013

(54) EVENT DATABASE FOR EVENT SEARCH AND TICKET RETRIEVAL

(71) Applicants: SURESH PARTHASARATHY, Hyderbad (IN); SUBRATA ROYCHOUDHURI, Hyderbad (IN); ANUJ ARORA, Hyderbad (IN); PHANINDRA KANUMURI, Hyderbad (IN); MANISH KANSAL, Hyderbad (IN); SRIKRISHNA SATISH DEVU, Hyderbad (IN); SARABJIT SINGH SEERA, Hyderbad (IN)

(72) Inventors: SURESH PARTHASARATHY, Hyderbad (IN); SUBRATA ROYCHOUDHURI, Hyderbad (IN); ANUJ ARORA, Hyderbad (IN); PHANINDRA KANUMURI, Hyderbad (IN); MANISH KANSAL, Hyderbad (IN); SRIKRISHNA SATISH DEVU, Hyderbad (IN); SARABJIT SINGH SEERA, Hyderbad (IN)

(73) Assignee: MICROSOFT CORPORATION, REDMOND, WA (US)

(21) Appl. No.: 13/189,099

(22) Filed: Jul. 22, 2011

(51) Int. Cl. G06F 17/30

(52) U.S. Cl. 707/692; 707/723; 707/706; 707/E17.005

(57) ABSTRACT

Methods, systems, and computer-readable media for managing event data and exploring the event data in an event database are provided. A data acquisition system may process the event database to remove duplicates and assign event data ranks to the event data. The event data rank may be based on query log data. In turn, a search engine communicatively connected to the event database may generate search results that include the event data. The search engine may receive an event data search request from a user. The event data matching the event data search request is retrieved from the event database and formatted, by the search engine, for display in rank order based on the event data rank, proximity of user location to an event location, and extent of query match in various event fields like title, description, etc.

### BACKGROUND

Conventionally, search engines are configured to provide results that include one or more terms of a search query. Conventional search engines may use indices storing references to electronic documents and the terms included in the electronic documents to generate the results. The search engine includes the references to the electronic documents identified in an index having similar terms in the results.

A typical search experience to buy tickets, via the conventional search engine, for an event is a multistep, cumbersome process. First, the conventional search engines do not aggregate data across multiple ticket providers to provide a rich ticket search experience. Second, the user may need to access multiple niche ticket search engines to locate a ticket for the event the user is interested in. Third, niche ticket search engines do not facilitate broad event data results like a generic search engine. In other words, these niche ticket search engines usually surface data from a single provider. These conventional, niche ticket search engines do not allow the user to quickly compare and chose best available tickets across multiple providers.

For instance, the niche ticket search engines may receive an event data search request and provide an interface for the users to purchase event tickets on-line. These conventional, niche ticket search engines allow users to browse or search a list of events associated with a particular provider, to select an event, e.g., “Celtics v. Heat,” to choose their specific seats within a venue for the selected event, and to submit their purchase request for the selected event. The niche ticket search engines provide some convenience for purchasing tickets, but place much of the burden of comparing similar tickets from multiple providers on the user. Further, these conventional search engines are narrowly focused and fail to provide related information about a venue, performer images, or recent videos of the performers in response to the event data search request.

### SUMMARY

Embodiments of the invention overcoming these and other problems in the art relate in one regard to a computer system, computer-readable medium, and computer-implemented method to manage and locate event data. The computer system selects search results that include event data not previously viewed by the user.

The computer system allows a user to search through and explore event data related to a user's event data search request. The computer system includes a database and a server. The database is configured to store event data, attributes for the event data, and rich information associated with the event data. The server is communicatively connected to the database. The server retrieves event data in response to the event data search request. In turn, a graphical user interface is generated to render the event data and the rich information associated with the event data not previously viewed by the user. The event data is displayed in a rank order based on social media information associated with the event data, proximity of the location associated with the event data to the user that provided the event data search request, or the dates included in the event data.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 is a network diagram that illustrates an exemplary computing system in accordance with embodiments of the invention;

FIG. 2 is a block diagram that illustrates the data acquisition components of an exemplary event database system in accordance with embodiments of the invention;

FIG. 3 is a logic diagram that illustrates a method to manage event data in accordance with embodiments of the invention;

FIG. 4 is another logic diagram that illustrates a method to locate event data in accordance with embodiments of the invention; and

FIG. 5 is a block diagram that illustrates an exemplary computer in accordance with embodiments of the invention

### DETAILED DESCRIPTION

This patent describes the subject matter for patenting with specificity to meet statutory requirements. However, the description itself is not intended to limit the scope of this patent. Rather, the inventors have contemplated that the claimed subject matter might also be embodied in other ways, to include different steps or combinations of steps similar to the ones described in this patent, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described. Further, embodiments are described in detail below with reference to the attached drawing figures, which are incorporated in their entirety by reference herein.

Embodiments of the invention include a computer system for managing and locating event data. The computer system may include a data acquisition system and a search engine. The data acquisition system generates an index that may be utilized by the search engine to locate event data.

In one embodiment, event data may be aggregated from multiple providers by the data acquisition system. In turn, the data acquisition may, in certain embodiments, merge interesting features for duplicates identified in the index. By combining event data from various providers, the data acquisition system may create index records that have rich event data. Once the event data is merged, the data acquisition system may also remove duplicates identified in the index. In some embodiments, the data acquisition system assigns event ranks to the event data stored in the index. The rank calculated for the event data by the data acquisition system may include popularity data extracted from query logs or social media information.

For instance, the index may store event data that may be utilized by the search engine to provide an interface for completing a purchase of one or more tickets associated with an event that is identified by a user. The search engine may transmit instructions to generate a search page for users to query the index for event data occurring in specific cities; events for specific performers, bands, sports teams; events for a specific distance from a location of the user; public events, private events, or events for a specific date. The search page may include several filtering controls that allow the user to narrow the event data search request that is transmitted to the search engine.

Accordingly, the search engine provides search results that match the event data search request. The search results may include events that require admission by a ticket, events that do not require a ticket, public events, private events, etc. In some embodiments, the event data included in the search results are ranked and displayed based on any combination of the following: popularity, proximity, date, weather, etc.

As one skilled in the art will appreciate, the computer system may include hardware, software, or a combination of hardware and software. The hardware includes processors and memories configured to execute instructions stored in the memories. In one embodiment, the memories include computer-readable media that store a computer-program product having computer-useable instructions for a computer-implemented method. Computer-readable media include both volatile and nonvolatile media, removable and nonremovable media, and media readable by a database, a switch, and various other network devices. Network switches, routers, and related components are conventional in nature, as are means of communicating with the same. By way of example, and not limitation, computer-readable media comprise computer-storage media and communications media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read only memory (ROM), electrically erasable programmable read only memory (EEPROM), flash memory or other memory technology, compact-disc read only memory (CD-ROM), digital versatile discs (DVD), holographic media or other optical disc storage, magnetic cassettes, magnetic tape, magnetic disk storage, and other magnetic storage devices. These memory technologies can store data momentarily, temporarily, or permanently.

In yet another embodiment, the computer system includes a communication network having an index, event data providers, client computers, a search engine, and a data acquisitions system. The index is configured to store event data acquired by the data acquisition system. A user may generate a query at the computer, which is communicatively connected to the search engine. In turn, the computer may transmit the event data search request to the search engine. The search engine may use the search request to locate event data search results in the index. The search engine may communicate the search results, including matching event data to the user.

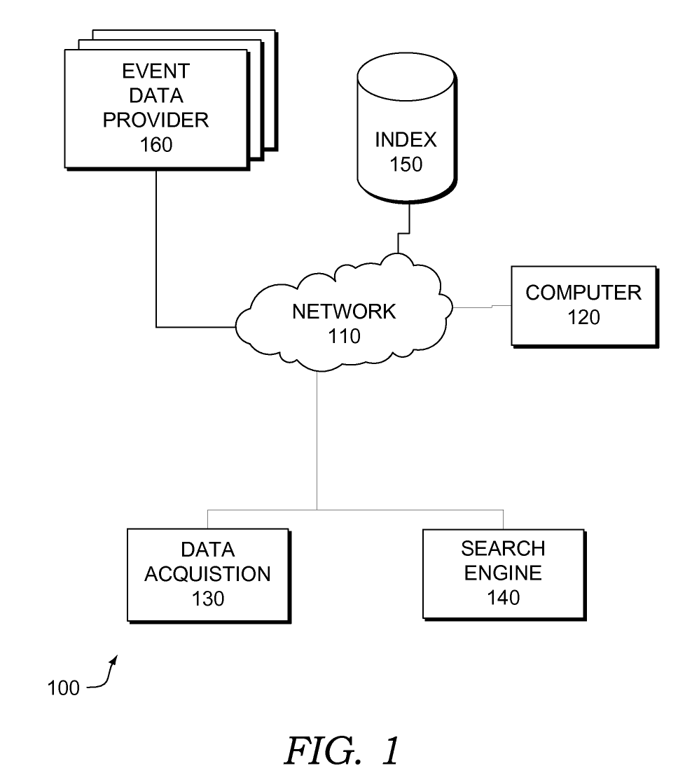

FIG. 1 is a network diagram that illustrates an exemplary computing system 100 in accordance with embodiments of the invention. The computing system 100 shown in FIG. 1 is merely exemplary and is not intended to suggest any limitation as to scope or functionality. Embodiments of the invention are operable with numerous other configurations. With reference to FIG. 1, the computing system 100 includes a network 110, computer 120, data acquisition system 130, search engine 140, index 150, and event data provider 160.

The network 110 enables communication among the various network devices and resources. The network 110 connects computer 120 and search engine 140. The data acquisition system 130, index 150, and event data provider 160 are also connected to network 110. The network 110 is configured to facilitate communication between the computer 120 and the search engine 140. It also enables the data acquisition system 130 to receive the event data that is formatted for storage in the index 150. The network 110 may be a communication network, such as a wireless network, local area network, wired network, or the Internet. In an embodiment, the computer 120 interacts with the search engine 140 utilizing the network 110. For instance, a user of the computer 120 may generate an event data search request. In response, the search engine 140 interrogates the index 150 for search results that include web pages, images, videos, or other electronic documents that match the event data search request generated by the user.

The computer 120 allows the user to view event data received from the search engine 140. Moreover, the computer 120 may allow the user to complete purchase transactions for tickets associated with the received event data. The computer 120 is connected to the search engine 140 via network 110. The computer 120 is utilized by a user to generate search words, to hover over objects, or to select links or objects, and to receive results or web pages that are relevant to the event data search terms, the selected links, or the selected objects. The computer 120 includes, without limitation, personal digital assistants, smart phones, laptops, personal computers, gaming systems, set-top boxes, or any other suitable client computing device. The computer 120 includes user and system information storage to store user and system information on the computer 120. The user information may include search histories, cookies, and passwords. The system information may include Internet Protocol addresses, cached web pages, and system utilization. The computer 120 communicates with the search engine 140 to receive the search results or web pages that are relevant to the event data search terms, the selected links, or the selected objects.

The data acquisition system 130 receives event data from multiple event data providers 160, formats the event data, and stores the information in a searchable index 150. The data acquisition system 130 is a server device that is connected to network 110, index 150, and event data providers 160. In some embodiments, the data acquisition system includes a temporary storage area for temporarily storing event data that is received from the event data providers 160. The corpus of event data received from the event data providers is stored in the temporary storage area.

In some embodiments, the data acquisition system 130 performs several pre-processing functions, such as schema normalization, ranking, duplicate removal, and merging. Because the event data is received from multiple event data providers 160, the raw event data is preprocessed and formatted in accordance with a selected schema. In one embodiment, the schema is created in extensible markup language (XML). For instance, the selected schema may require that the event data providers 160 include certain types of information in the event data provided to the data acquisitions system 130. The selected schema may have required attributes and optional attributes. In an embodiment, the required attributes are event name and event venue. The optional attributes may include price, descriptions, category, etc. Thus, the data acquisition system 130 may ignore event data not having the required attributes. In certain embodiments, the data acquisition system 130 may drop event data having a past date. For instance, if the event already took place, the data acquisitions system 130 does not include the event in the index 150.

The data acquisition system 130 may utilize categories specified in the schema to cluster the event data. For instance, the schema may include several categories, e.g., sports, money, theater, movie, public, private, education, travel, food, etc. However, the categories provided by the schema may not exactly match the categories associated with the event data. Thus, the data acquisition system 130 may generate a taxonomy based on the category information provided by the various event data providers 160. The data acquisitions system 130 attempts to identify parent-child relationships and sibling relationship among the categories specified by the schema and the event data providers. After the category relationships are identified, the data acquisition system 130 specifies a hierarchy that is utilized to cluster the event data. Thus, the taxonomy is a hierarchy of relationships generated by the data acquisition system 130 that is utilized to categorize the event data.

The temporary storage includes a record identifier generated by the data acquisition system 130 for the event data received from the event data providers 160. In turn, the data acquisitions system 130 associates the retrieved event data with one or more categories. The temporary storage may be utilized to store values for the various attributes, including category, event name, price, description, venue name, date, city, state, and record identifier. In some embodiments, the data acquisition system 130 may receive event data from the event data providers periodically, e.g., once a week, once a month, twice a week, etc. The new event data may cause the data acquisitions system 130 to update the index 150.

When all the event data from the event data providers 160 are formatted in accordance with the schema, the data acquisition system 130 may normalize several of the attributes associated with event data. In some embodiments, the data acquisition system may normalize location information, including city, state, and country information. Here, the data acquisition system 130 associates abbreviations and typographical errors of the location information with a preferred representation of the data. For instance, “ny,” nyc, “newyork,” “new yirk,” “new york city,” may be normalized to refer back to “new york.”

In certain embodiments, the data acquisition system 130 may use the normalized location information for the event data to initiate a duplicate removal process. The event data may be grouped based on the location information. In turn, the data acquisition system 130 looks for duplicates within each group. Within each group, duplicates may be identified based on matching event names and event dates. In one embodiment, the data acquisitions system 130 may utilize synonym lists to identify the duplicates in the event data. Also, the data acquisition system 130 may utilize cosine text similarity measures to determine whether the event name matches. In other embodiments, the data acquisition system 130 may determine whether each attribute existing for the identified duplicate match before marking the event data as a duplicate. If the provided attributes are a match, the event data is marked as a duplicate. If the provided attributes do not match, the event data is retained in the temporary storage.

The identified duplicates are dropped by the data acquisition system 130. In one embodiment, the duplicates may be merged based on the attribute scores associated with the event data attributes. For instance, the data acquisition system may specify attribute scores that specify a trustworthiness, quality, or visual appeal associated with the duplicate event data. The data acquisition system 130 compares the attribute scores for the attributes and retains the data having the higher score and deletes the data having the lower score. In other embodiments, the duplicate event data having the most complete record is retained by the data acquisition system 130. For instance, the data acquisition may determine that event data provider A and event data provider B have duplicate event data. In turn, the data acquisition system 130 may compare the completeness, accuracy, and visual richness of the event data from both providers. In turn, the data acquisition system may select the event data from event data provider A, if the event data from event data provider A has better information for the event. In one embodiment, the data acquisition system 130 may utilize the duplicate information to locate new synonyms to update the synonym lists. For instance, the duplicate event data may include an abbreviation for the venue name that may be included in the synonym list.

The data acquisition system 130 generates an event data rank for each event data record stored in temporary storage. The assigned event data rank may be based on an occurrence frequency of the event data in a query log associated with the search engine. Additionally, the assigned event data rank may be based on a number of positive reviews associated with one or more performers, actors, stars, or players associated with the event. In one embodiment, the event data rank may be based on a combination of selected variables, e.g., frequency in recent query log data, social media reviews, venue ratings, etc. The value associated with the variables collected for each record may be combined in a linear fashion to arrive at a score. For instance, each of the values for the variables may be normalized to range between 0 and 1. In turn, the normalized values are summed to determine the rank for the event data. In other embodiments, a regression model may be utilized to calculate the event data rank based on the normalized values for the event data. The event data rank is stored in the temporary storage by the data acquisition system 130. In turn, the data acquisition system 130 moves the event data records from the temporary storage to index 150.

The search engine 140 is utilized to traverse the index 150 and generate a search results page in response to a search request, including event data search requests. The search engine 140 is communicatively connected via network 110 to the computers 120. The search engine 140 is also connected to index 150. In certain embodiments, the search engine 140 is a server device that generates visual representations for display on the computers 120. The search engine 140 receives, over network 110, selections of words or selections of links from computers 120 that provide interfaces that receive interactions from users.

In certain embodiments, the search engine 140 communicates an event data search request to the index 150. The search engine 140 utilizes the event data search request to identify results that match the search request. In turn, the search engine 140 examines the results and provides the computers 120 a set of uniform resource locators (URLs) that point to web pages, images, videos, or other electronic documents that satisfy the search request. In certain embodiments, the result pages generated by the search engine 140 include event data matching the event data search request in addition to the URLs. In some embodiments, the event data is dynamically ranked based on, among other things, the event data rank, location, date, reviews for the event, social media preferences associated with the user that issued the search request, weather, etc. In some embodiments, the user opts-in to allow the search engine to access his/her social media information.

In one embodiment, the event data selected for display may vary based on whether the user previously viewed any of the event data stored in the database. The search engine may track a user's interaction with the event data to determine whether a user viewed or interacted with the event details. In some embodiment, search session information may store search requests, event details presented, and event details that the user interacted with. The event details may include trivia, games, images, videos, news, venue data, weather associated with venue, etc. For instance, if a user previously viewed an image associated with an event during a prior search session, the search engine may select a video associated with the event for the search results page if the search session information shows that the user did not view the video during a previous search session. The search engine 140 may dynamically alter the event details included in the search results page based on a previous interaction with the user. Accordingly, the search engine shows fresh event details to the user in each subsequent search result page that includes details for an event previously searched by the user.

The index 150 stores words and a posting list. The words are typically associated with electronic documents like, web pages, videos, text files, and images. The posting list allows the user to identify the documents associated with the words. In some embodiments, the index 150 also stores event details. The event details may include event name, price, location, date, event data rank, etc. The search engine 140 may request event details from the index 150. In turn, the index 150 locates the event details that satisfy the request and transmits those records to the search engine 140.

The event data providers 160 transmit raw event details to the data acquisition system 130. In some embodiments, the event details may be associated with fundraiser events, public events, private events, fairs, festivals, etc. The event data providers 160 may include third-party providers and a crawler programmed to find event data included in documents available on the Internet. In one embodiment, the third-party providers may specialize within specific industries. For instance, one third-party provider may specialize in art events, another third-party provider may specialize in sport events, and so forth. Furthermore, the third-party providers may specialize in events for specified segments of the population, e.g., events in various cities, events for specific affinity groups, engineers, lawyers, etc. The crawler may identify areas not covered by the third-party providers. In turn, the crawler may search the Internet for event details in those areas. For instance, the crawler may determine that the third-party providers do not provide event details for cricket events, foosball events, table tennis events, or birthday parties. The crawler would then begin crawling the Internet for electronic documents associated with cricket events, foosball events, table tennis events, or birthday parties. The electronic documents may include, among other sources, newspapers, social sites, and blogs. The crawler may extract the event details in accordance with a schema selected by the data acquisition system 130 and transmit the extracted details to the data acquisitions system 130 for further processing.

The event details provide information about performers, tickets, venue, location, etc. The data acquisition system 130 processes the raw event details received from the event data providers 160 and index the formatted event details in the index 150. The event detail may include documents, ticketing information, metadata, image, video, etc. The documents, ticketing information, or metadata may be used by the data acquisition system 130 to store the event details in an appropriate location in the index 150.

Accordingly, the computing system 100 is configured with a search engine 140 that provides results that include URLs and event data to the computers 120. The search request received from the computer 120 is received by the search engine, which traverses the index 150 to obtain results, including event details that satisfy the search requests. The search engine transmits the results to the computers 120. In turn, the computers 120 render the results for the users.

As explained above, in certain embodiments, the data acquisition system 130 generates formatted event data that is stored in the index 150. The data acquisition system receives raw event data from event data providers 160. In turn, the data acquisitions system reformats the raw event data and stores the reformatted raw data in an index. In some embodiments, the data acquisition system calculates an event data rank for the reformatted raw event data.

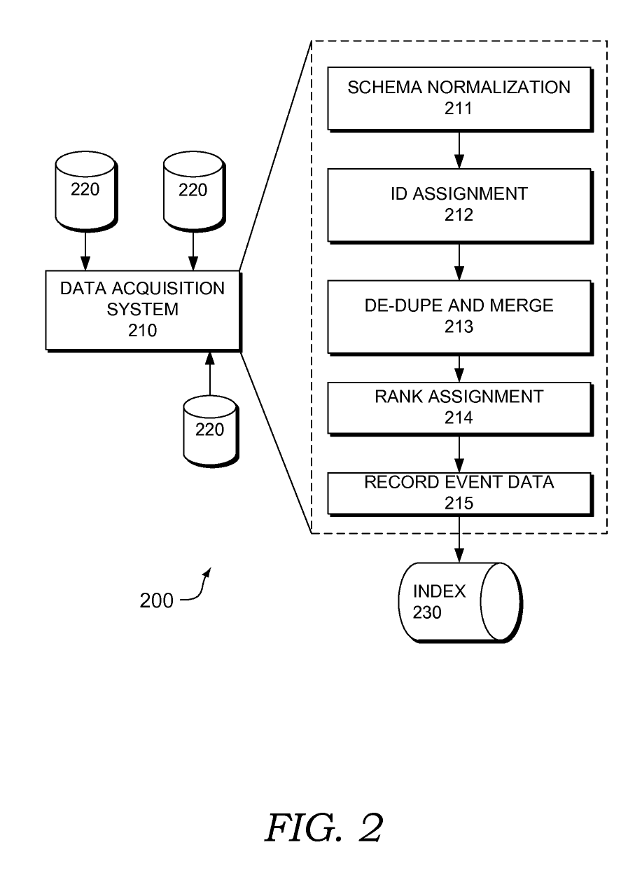

FIG. 2 is a block diagram that illustrates the data acquisition components of an exemplary event database system 200 in accordance with embodiments of the invention. The event database system 200 includes data acquisition system 210, event data providers 220, and index 230.

The data acquisition system 210 receives raw event data from event data providers. In turn, the raw event data is reformatted in several processing components of the data acquisition for storage in the index 230. The processing components may include schema normalization component 211, ID assignment component 212, de-dupe and merge component 213, rank assignment component 214, and record event data component 215. The acquisition system utilizes these components to remove duplicates provided by the event data providers 220 and to rank the event data.

Schema normalization component 211 is configured to create a taxonomy from the raw event data. The taxonomy is configured to include attributes identified in the raw event data. For instance, the attributes may include event name, venue name, city name, state name, and event start time. In other words, the schema normalization component 211 extracts attributes from the raw event data and matches the attributes with the schema selected for the reformatted event data. In some embodiments, the attributes selected for the reformatted event data include common attributes found in the raw event data from the event data providers. In other embodiments, the schema for the raw event data is configured to include at least, event name, venue name, city name, state name, and event start time.

In turn, the values for the attributes may be normalized by the schema normalization component 211. In some embodiments, the event names and locations may be normalized by identifying synonyms for locations and event names. In one embodiment, the synonyms may be identified from query log data. The raw event data is associated with attributes of the select schema. For instance, the values associated with city name and state name may be normalized to include misspells, abbreviations, and nicknames. In some embodiments, the event data provider may transmit the synonym list to the data acquisitions system 210. For instance, the synonym list may indicate that a country attribute with values of “us,” “usa,” “united states,” “america,” “united states america,” “united states of america,” etc. refer to the same country location. The schema normalization component 211 may utilize synonym lists to identify the synonyms of the country attribute “us” included in the raw event data. In turn, the values for the country location attribute that match the specified synonyms are updated with a common representation of the country location, e.g., “usa.” The schema normalization component 211 also processes the remaining attributes with other synonym lists for venue name, city name, state name, etc. In some embodiment, the schema normalization component 211 distinguishes between common values based on state or country. For instance, “NL, Canada” and “NL, Mexico” are recognized as different locations by the schema normalization component 211. Thus, a country or state value may be verified as referring to the same location before confirming that city, county, or state values in the event data refer to the same place.

In some embodiments, the schema normalization component 211 may process the normalized event data to identify additional synonyms not included in the synonym lists. For instance, common subsequences may be located within the values for the city name attributes. The common subsequence may be identified based on a similarity measure. Two or more common subsequences may be tagged as a potential synonym pair when the pair has a high threshold of similarity. In turn, the synonym lists are checked to verify the pair is not included within the synonym list. If the pair is already in the synonym list, it is ignored by the schema normalization component 211. If the pair is not in the synonym list, the pair is added to synonym list by the schema normalization component 211. For instance, the schema normalization component 211 may identify the following as synonym pairs not already included in a city synonym list: {Foxboro, Foxborough}, {Beverly Hills, Beverley Hills}, and {Arlington Hts, Arlington Heights}.

In turn, normalized event data may by assigned an identifier by the ID assignment component 212. In one embodiment, each event is assigned an index identifier in addition to identifiers specified in the raw event data received from the event data providers 220 by the ID assignment component 212. In an alternate embodiment, the index identifier may be based on, or include, the identifiers specified in the raw event data for the event.

In some embodiments, the normalized event identified is also processed by a de-dupe and merge component 213, which removes duplicates from the normalized event data. Because the data acquisition's system received raw event data from multiple event data providers 220 the normalized event data may include duplicate events. In certain embodiments, past events are removed from the normalized data. For instance, when the event date or event start time has transpired, the de-dupe and merge component 213 drops the event data.

In another embodiment, de-dupe and merge component 213 may merge events from duplicate events identified in the normalized event data. The de-dupe and merge component 213 calculates a similarity measure between the attributes for each event included in the normalized event data. In some embodiments, the match strictness may be specified by the index designer. For instance, values for event name and venue name attributes may be compared for fuzzy matches and values for city name, state name, and event date, e.g. day and start time may be compared for exact matches. In one embodiment, the de-dupe and merge component 213 compares the value of the event name with all other event names. If the compared values are included in a synonym list or a similarity measure between the values is above a specified threshold, the other attributes, venue, city, state, event date are checked to confirm that they also match. When all checked values match, the de-dupe and merge component 213 identifies one of the events as a duplicate. If the compared values are not included in a synonym list or the similarity measure between the values is below a specified threshold, the event is not identified as a duplicate.

In some embodiments, the events may be grouped based on city-state combination by the de-dupe and merge component 213. The grouped normalized event data is processed within the city-state combinations for duplicates. For instance, the all normalized event data for Redmond, Wash., may be grouped together by de-dupe and merge component 213. In turn, the event data for Redmond, Wash., is processed for duplicates. Similarly, all normalized event data for Richmond, Va., may be grouped together by the de-dupe and merge component 213, which looks for duplicates within this group. Thus, the de-dupe and merge component 213 looks for duplicate events within the locations associated with the group.

In one embodiment, the de-dupe and merge component 213 may create subgroups based on venue name and time match. Within the city state group, a venue time sub-group is formed when the venue name and time match exactly. Within the venue time sub-group, the similarity measure threshold on the event name match may be reduced by the data acquisition system 210 to allow the de-dupe and merge component 213 to include more potential duplicate events. For instance, the similarity measure threshold may be reduced by 5% to extract more potential duplicates from the normalized event data.

In turn, the de-dupe and merge component 213 may merge the identified duplicate events. In certain embodiments, the de-dupe and merge component 213 maintains attribute scores for the event data providers 220. The attribute scores measure the accuracy of the raw event data received from the provider. In some embodiments, the score may be ordered from high, medium, neutral, to low. For instance, the event data providers 220 that specialize in particular events may be assigned a high score when the raw event data is accurate. On the other hand, if the raw event data is incorrect, the attribute scores may be neutral or low based on the number of errors included in the raw event data. In some embodiments, the scores may be altered based on feedback received from users. When users provided negative feedback on the quality of the event data, the attribute score for the event data provider is lowered by the data acquisition system. The de-dupe and merge component 213 may obtain additional attributes or additional event data for the first event from the duplicate second event. For instance, the duplicate second event may include additional attributes not present in the first event, for instance, performer name attributes, venue weather attributes, etc. The de-dupe and merge component 213 may add the additional attributes and corresponding values to the first event. In an alternate embodiment, the de-dupe and merge component 213 may include a description field that includes the additional attributes and the corresponding values. In some embodiments, the first event data and duplicate second event data are compared to determine whether the first event data includes data that is more interactive or of a better quality, e.g. high-definition video versus regular video, full-screen images versus thumbnail, dynamic content versus plain text. In one embodiment, if the first event data has better quality event data, the first event data is retained and the second duplicate event data is dropped. In some embodiments, the de-dupe and merge component 213 may retain both sets of event data in a single event data record and the duplicate event data record is dropped.

In one embodiment, event data received from a crawler may be selected over the event data received from other event data providers 220. Alternatively, the event data received from the other event data providers 220 may be selected over the event data received from the crawler.

The duplicate event data is identified by the de-dupe and merge component 213 based on matches within the event data attributes. The matches are determined based on a synonym list or a similarity measure. As discussed above, the values for event name and venue name attributes may be compared for fuzzy matches and values for city name, state name, and event date, e.g., day and start time may be compared for exact matches. The exact match is identified by the de-dupe and merge component 213 if the values are equal. A fuzzy match is identified by the de-dupe and merge component 213 if the values are approximate. In one embodiment, approximate values may be determined from various synonym lists, event name synonym lists, or venue synonym lists. In another embodiment, the approximate values may be identified based on a similarity range identified by the index designers. For instance, a range 70-100% likelihood of similarity may be considered an approximate value. In certain embodiments, the synonym lists may be generated from query log data. For instance, if a first word and second word are typed by different users, and the same object is clicked by the different users, the first and second word may be identified as synonyms based on the query log data. The query log data may reveal that different users may enter “congress,” “senate,” “capitol hill,” “house of representatives,” in a search engine that returns links about neighborhoods in Seattle, links about the legislative process, links about senators, etc. The query log data may also reveal that the different users that entered those terms all selected a link for capitol building. From this query log data the data acquisition system 210 may identify “congress,” “senate,” “capitol hill,” and “house of representatives” as synonyms.

Additionally, the data acquisition system 210 may identify venue synonyms from the normalized event data, including the duplicate data. For instance, the normalized event data may be filtered to create sub-groups within the grouped normalized data. In the city-state groups, the subgroups are formed based on event name and time that match. The values for the venues within these sub-groups may be identified as synonyms by the data acquisition system 210. For instance, “HHH metrodome” and “Hubert H. Humphrey Metrodome” may form a subgroup based on the match of the event name and time. Thus, the venue synonym list may be updated to include “HHH metrodome” and “Hubert H. Humphrey Metrodome” as synonyms.

In certain embodiments, the matches that are identified by the data acquisition system 210 may utilize a cosine text similarity measure. The cosine similarity measure performs a string comparison on two word bags. The cosine similarity measure equals the extent of word match divided by the product of square roots of the bag sizes. In some embodiments, the data acquisition system 210 may identify and remove stop words and common words from the word bags. Stop words include words that are included in the normalized event data above a specified threshold. For instance, stop words may include “the,” “a,” “in,” “by,” “on,” etc. The data acquisition system 210 counts an occurrence for the words in the normalized event data and tags the words having an occurrence over a specified threshold. The data acquisitions system 210 also identifies and removes common words that are in the words bags. The common words appear exactly in both word bags. For instance, common words may include “garden,” “theater,” “museum,” “stadium,” “park,” etc. In turn, the cosine similarity measure may be determined based on a bag of words that exclude common words and stop words. In some embodiments, instead of removing the stop words and common words, the cosine similarity measure may be discounted based on the occurrence of the stop word or common word in the normalized event data. For instance, if the occurrence of the stop words is above a specified threshold, the cosine similarity measure of the bag of words may be reduced by 10%. If the occurrence of the common words is above a specified threshold, the cosine similarity measure of the bag of words may be reduced by 5%.

The merged event data may be ranked by the rank assignment component 214. The rank assignment component 214 calculates an event data rank for the merged event data. The event data rank may represent the popularity and importance of the event. The event data rank is associated with the event data. In one embodiment, the event data rank may be calculated based on query log data, event data quality, and social media information. The metrics associated with event data rank, among other things, include venue popularity, performer popularity, performer buzz, and normalized event data quality. The values of the metrics may be computed from query logs and social media data by the rank assignment component 214. For instance, the number of times the performer was queried may be utilized as performer popularity. Alternatively, the number of followers the performer has on social media accounts may be utilized for the performer popularity. In still another embodiment, an official webpage associated with the performer may count the number of visitors; so, the visitor count may be utilized as performer popularity. In certain embodiments, the popularity for all performers in the normalized event data is determined and the max popularity may be utilized to normalize the performer popularity count. The normalized count may then be utilized as the performer popularity metric. In another embodiment, if the performer is not located in the query log data or the social media data, the rank assignment component calculates the average popularity for all performers in the normalized event data, where outliers are ignored. The average of the normalized performer popularity count is assigned as the performer popularity metric when the performer is not located in the query log data or the social media data.

In some embodiments, like performer popularity, the venue popularity metric is computed from the query logs and social media data. The number of times the venue was queried may be utilized as venue popularity. Alternatively, the number of followers the venue has on social media accounts may be utilized for the venue popularity. In still another embodiment, an official webpage associated with the venue may count the number of visitors; so, the visitor count may be utilized as venue popularity. In certain embodiments, the popularity for all venues in the normalized event data is determined and the max popularity may be utilized to normalize the venue popularity count. The normalized count may then be utilized as the venue popularity metric. The performer buzz may be associated with a rate of change associated with performer popularity. For instance, when the rate of change of the performed popularity over a three-hour period is increasing, the performer buzz metric may increase the event data rank. When the rate of change of the performed popularity over a three-hour period is decreasing, the performer buzz metric may decrease the event data rank.

The rank assignment component 214 determines the normalized event data quality from event data quality features, such as presence of images, presence of categories, presence of ticket information, title length, unique words in title, description length, etc. If several of the features are present in the event data, the quality is assigned a high value. In some embodiments, as discussed above, the quality may range from high, medium, neutral, to low. When the document quality is high or medium, the normalized event data quality metric may increase the event data rank. When the document quality is neutral, the normalized event data quality metric has no impact on the event data rank. When the document quality is low, the normalized event data quality metric may decrease the event data rank. For instance, a medium normalized event data quality metric is assigned by the rank assignment component 214 to the normalized event data when the normalized event data includes event title, event description, and a thumbnail or larger image associated with the event data. In certain embodiments, the event data rank is the sum of, among other things, the venue popularity metric, the performer popularity metric, the performer buzz metric, and the normalized event data quality metric. In another embodiment, the event data rank may be extracted from the raw event data received from the event data providers.

In other embodiments, the event data rank is assigned by multiple additive regression trees created by the rank assignment component 214. The rank assignment component 214 may utilize the venue popularity metric, the performer popularity metric, the performer buzz metric, and the normalized event data quality metric. A feature vector of the venue popularity metric, the performer popularity metric, the performer buzz metric, and the normalized event data quality metric from the normalized event data is used by the rank assignment component 214 to arrive at the event data rank. In certain embodiments, the event data rank extracted from the raw event data received from the event data providers may be used as training data for the multiple additive regression trees.

The record event data component 215 stores the ranked event data in the index 230. The index 230 stores, among other things, the event data attributes and event data rank. In turn, the index may be utilized to respond to search requests.

The event data providers 220 include a crawler and various event providers. The event providers include box offices, affinity groups, sport teams, artists, etc. The event data providers 220 provide the data acquisition system with raw event data. The raw event data is processed for storage in the index 230.

The index 230 stores the reformatted raw event data, keywords for electronic documents, and reference locations associated with the electronic documents. The reformatted raw event data may include ticketing information that is utilized to purchase tickets associated with an event.

In certain embodiments, the data acquisition system 210 manages the raw event data received from the event data providers. The data acquisition system may execute a computer-implemented method to manage the raw event data. In accordance, with the computer-implemented method the data acquisition system removes duplicates and ranks the event data. In some embodiments, the event data is stored in accordance with a schema selected by the data acquisition system 210.

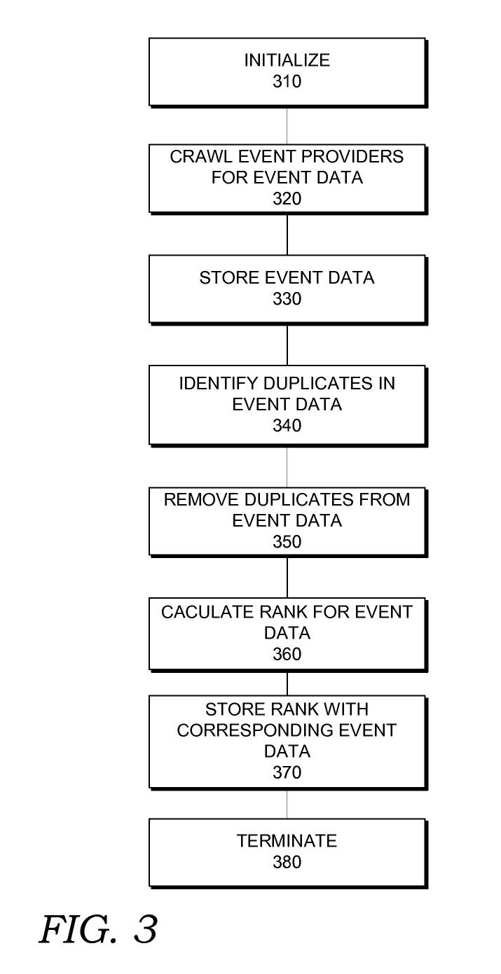

FIG. 3 is a logic diagram that illustrates a method to manage event data in accordance with embodiments of the invention. In step 310, the method initializes on the data acquisition system. In step 320, the data acquisition system may crawl the Internet for events. In certain embodiments, the data acquisition system, also, receives event data from various event data providers. In turn, the event data is stored in a temporary storage, in step 330. The data acquisition system may verify that the event data satisfies a structure associated with an event database, e.g. index. The event data may be reformatted when the event data does not satisfy the structure associated with the event database. The reformatted event data may be stored in the event database. The data acquisition system may check for duplicates. In one embodiment, duplicates are identified via synonym lists. The synonym lists may include click associations extracted from query logs. The click associations may indicate that two or more different words are synonyms because the two or more different words, e.g., previous search requests entered by users, refer to a common object retrieved by the users. In step 340, the duplicate event data is identified. In one embodiment, duplicates located in the event database are removed by the data acquisition system, in step 340. In one embodiment, removing duplicates located in the event database includes merging records based on scores associated with providers of the duplicate event data.

In step 360, the data acquisition system may calculate an event data rank for each record having event data in the event database. In certain embodiment, the event data rank is based on any combination of: query log data, social media, and event data quality. In other embodiments, the data acquisition system creates a regression model of various components, e.g., query log data, social media, event data quality, etc., of the event data rank calculation. The regression model may then be utilized to assign the event data rank. In an alternate embodiment, a cosine similarity measure may be utilized to identify duplicates in the event database. The data acquisition system may store the rank associated with the event in the event database at step 370. The event database may be part of an index utilized by a search engine. In turn, the method terminates at step 380.

In one embodiment, a search engine traverses the index to locate event data in addition to search results. The event data matching a search request received by the search engine is formatted for display. The search engine may dynamically rank the event data based on freshness to a user that provided the search request. In other embodiments, the rank may be dynamically assigned based on social media data or weather information. Accordingly, the search engine executes a method to locate event data in response to the search request.

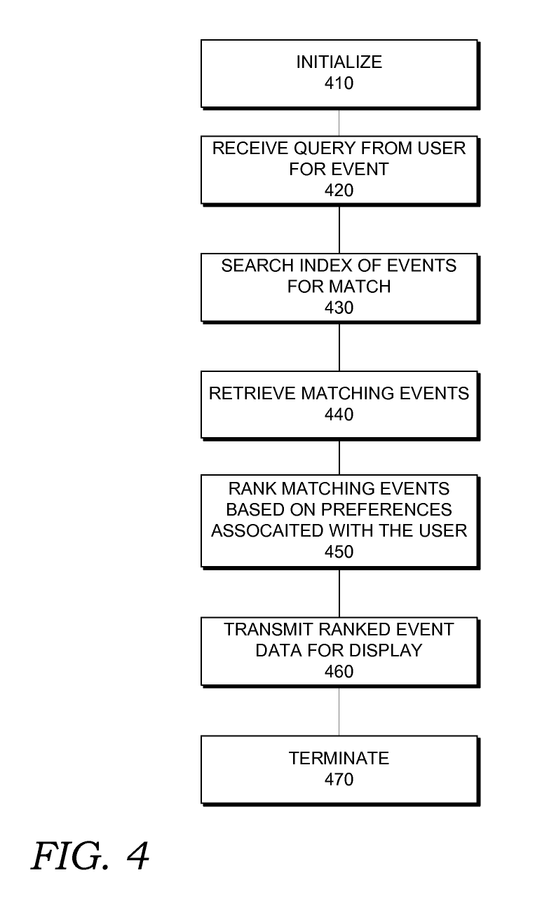

FIG. 4 is another logic diagram that illustrates a method to locate event data in accordance with embodiments of the invention. The method initializes in the step 410. In step 420, the search engine receives a search request for event data from a user. In step 430, the search engine searches an index having event data for a match to the search request. The search engine, in step 440, retrieves the event data matching the search request event data from the index, e.g., event database. The search engine may generate search results that include the event data matching the request. In turn, a display rank is assigned by the search engine, in step 450, to the matching events based on preferences associated with the user. In one embodiment, the preferences associated with the user include freshness of the matching event data to the user. In step 460, the ranked event data is transmitted with the search results in display rank order to a user. In other embodiments, the display rank order is modified dynamically based on proximity of user location to a location associated with the matching event data. In step 470, the method terminates.

Accordingly, the display rank may be dynamically assigned to the event data by the search engine. In some embodiments, the display rank may be based on the event data rank included in the index, proximity of a user location to the event location, proximity of event date, extent of search request match in the event name, extent of query match in description, category, social media data, etc. For instance, an event recommended or liked by a friend of the user may be ranked higher than other events having similar ranks. Also, an event tagged by friends may receive preferential treatment over other events that have higher ranks. In one embodiment, the user may opt-in to social media ranking and allow the search engine to access social media associated with the user. In another embodiment, the search engine may alter the graphical user interface displayed to the user to highlight event data, e.g., event name, event data, or performer.

The search results are displayed on a computer associated with the user that generated the search request. The computer displays the received search results in a graphical user interface configured by the search engine. The search results include event data in display rank order.

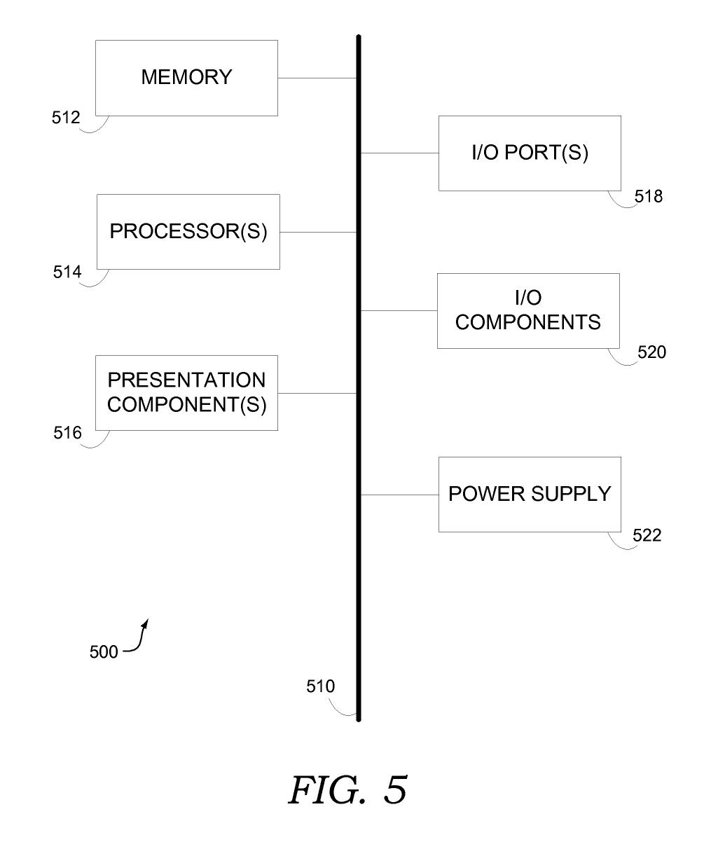

FIG. 5 is a block diagram that illustrates an exemplary computer in accordance with embodiments of the invention. Referring initially to FIG. 5 in particular, an exemplary operating environment for implementing embodiments of the present invention is shown and designated generally as computing device 500. Computing device 500 is but one example of a suitable computing environment and is not intended to suggest any limitation as to the scope of use or functionality of invention embodiments. Neither should the computing environment be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. Embodiments of the invention may be practiced in a variety of system configurations, including handheld devices, consumer electronics, general-purpose computers, more specialty computing devices, etc. Embodiments of the invention may also be practiced in distributed computing environments where tasks are performed by remote-processing devices that are linked through a communications network.

With reference to FIG. 5, computing device 500 includes a bus 510 that directly or indirectly couples the following devices: memory 512, one or more processors 514, one or more presentation components 516, input/output ports 518, input/output components 520, and an illustrative power supply 522. Bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 5 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 5 and reference to “computing device.”

Computing device 500 typically includes a variety of computer-readable media. By way of example, and not limitation, computer-readable media may comprise computer storage media and communication media. The computer storage media include, random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other medium that can be used to encode desired information and be accessed by computing device 500.

Memory 512 includes computer-storage media in the form of volatile and/or nonvolatile memory. The memory may be removable, nonremovable, or a combination thereof. Exemplary hardware devices include solid-state memory, hard drives, optical-disc drives, etc. Computing device 500 includes one or more processors that read data from various entities such as memory 512 or I/O components 520. Presentation component(s) 516 present data indications to a user or other device. Exemplary presentation components include a display device, speaker, printing component, vibrating component, etc.

In summary, the search results provided by the search engine may include event data, including ticket information that may be utilized to purchase a ticket. In one embodiment, the event data is ranked based on popularity as measured from query log data or social media data. In certain embodiments, the event data may be displayed based on freshness. In other words, the event data transmitted with the search results includes event data not previously viewed by the user. The event data may include trivia, games, images, videos, news, venue data, weather data, or performer data. In one embodiment, the event data may change depending on weather, e.g., during sunny days outdoor events may be displayed, during rainy days indoor events may be displayed, etc. Moreover, the events may alter based on whether the user is a visitor or a resident of a specified location. For instance, residents of a location may automatically be exposed to local event data at smaller venues at the specified location. The visitor to the specific location would not be exposed to local event data at smaller venues at the specified location unless the visitor requests to see the local event data. In some embodiments, the event data recommended by friends of the user is always displayed along with the other event data and search results matching the search request. In some embodiments, the graphical user interface may be dynamically altered based on the information previously viewed by the user to keep the rendered event data fresh.

The foregoing descriptions of the embodiments of the invention are illustrative, and modifications in configuration and implementation are within the scope of the current description. For instance, while the embodiments of the invention are generally described with relation to the figures, those descriptions are exemplary. Although the subject matter has been described in language specific to structural features or methodological acts, it is understood that the subject matter defined in the appended claims is not necessarily limited to the specific features or acts described above. Rather, the specific features and acts described above are disclosed as example forms of implementing the claims. The scope of the embodiment of the invention is accordingly intended to be limited only by the following claims.

We claim:

1. A computer-implemented method for managing event data, the method comprising:
receiving event data;
verifying that the event data satisfies a structure associated with an event database;
reformatting the event data when the event data does not satisfy the structure associated with the event database;
storing the event data in the event database;
checking the event database for duplicates;
removing duplicates located in the event database;
calculating an event data rank for each record having event data in the event database; and
storing the rank associated with the event in the event database.

2. The computer-implemented method of claim 1, wherein removing duplicates located in the event database further comprises:
merging records based on scores associated with providers of the duplicate event data.

3. The computer-implemented method of claim 1, wherein the event data rank is based on query log data.

4. The computer-implemented method of claim 1, wherein the event data rank is based on social media data.

5. The computer-implemented method of claim 1, wherein the event data rank is based on event data quality.

6. The computer-implemented method of claim 1, wherein the event data rank is calculated via a regression model of various components of the event data rank calculation.

7. The computer-implemented method of claim 1, wherein a synonym list is utilized to identify duplicates in the event database.

8. The computer-implemented method of claim 7, wherein the synonym list includes click associations extracted from query logs.

9. The computer-implemented method of claim 8, wherein the click associations indicate that two or more different search requests entered by users refer to a common object retrieved by the users.

10. The computer-implemented method of claim 1, wherein a cosine text similarity measure is utilized to identify duplicates in the event database.

11. The computer-implemented method of claim 1, wherein the event database is part of an index utilized by a search engine.

12. A computer-readable media storing computer useable instruction for performing a method for locating event data, the method comprising:
receiving a request for event data;
retrieving the event data matching the request event data from an event database;
generating search results that include the event data matching the request; and
transmitting the search results in display rank order to a user based on freshness of the matching event data to the user.

13. The media of claim 12, wherein the display rank order is modified dynamically based on proximity of user location to a location associated with the matching event data.

14. A computer system configured to locate event data, the computer system comprising:
a search engine configured to receive a request for event data from a user, retrieve event data matching the request from an event database, and obtain search results that include the matching event data in display rank order based on freshness of the matching event data included in the search results for the user.

15. The system of claim 14, wherein the search engine allows a user to initiate a purchase transaction via the matching event data obtained for the user.

16. The system of claim 14, wherein the display rank order is assigned based on at least one of: user location, social media data, weather, or an extent to which the matching event data stored in the event database is similar to the event data in the request.

17. The system of claim 14, wherein the matching event data includes public events and private events.

18. The system of claim 14, wherein freshness is measured based on a period of time that passed since the user received certain pieces of information associated with the matching event data.

19. The system of claim 14, wherein the search results include any of the following: images, games, trivia, videos, or news associated with the matching event data.

20. The system of claim 14, wherein the event database is configured to store venue name, event, start time, and historical information associated with the venue.
